(19) United States
(12) Patent Application Publication
(10) Pub. No.: US 2011/0142532 A1
(43) Pub. Date: Jun. 16, 2011

(54) STRUT FOR EXHAUST NOZZLE AND METHOD OF MANUFACTURE

(75) Inventor: Bulent Diemirbey, Coto de Caza, CA (US)

(73) Assignee: ROLLER BEARING COMPANY OF AMERICA, INC., Oxford, CT (US)

(21) Appl. No.: 12/843,155

(22) Filed: Jul. 26, 2010

Related U.S. Application Data
(60) Provisional application No. 61/228,202, filed on Jul. 24, 2009.

(51) Int. Cl. F16C 11/06; B23H 1/00; B23P 11/00; B21D 53/84; B22F 3/24

(52) U.S. Cl. 403/56; 219/69.17; 29/428; 29/505; 419/28

(57) ABSTRACT

A strut for the exhaust nozzle for a turbine engine includes a rod having a body member which has two opposite ends, a first rod end at one end and a second rod end at the other end. Each rod end defines a mounting aperture having an interior surface, and there is a ball member disposed in the mounting aperture to form a spherical plain bearing. At least one of the spherical plain bearings spherical bearing does not include an outer ring. At least one ball member may be made by molding, compacting, and sintering powdered chromium-cobalt alloy into an unfinished ball member, machining the unfinished ball member using wire EDM to provide a machined ball member, and jig grinding a chamfer onto the machined ball member.

### CROSS REFERENCE TO RELATED APPLICATION

This application claims the benefit of U.S. Provisional Patent Application No. 61/228,202, filed on Jul. 24, 2009, the contents of which are incorporated herein by reference in their entirety.

### FIELD OF THE INVENTION

This invention relates to turbine engines with exhaust nozzles, and more particularly to struts used to control the positions of exhaust nozzles during operation of turbine engines.

### BACKGROUND

The configuration of some exhaust nozzles for turbine engines (for example, those on jet aircraft) can be adjusted to accommodate changing engine conditions by changing the position of one or more adjustable flaps in the exhaust nozzle. A strut connects an adjustable flap to an actuator which controls the flap position. In a conventional design, a strut indicated at 10 in FIG. 1 comprises a rod 12 having two rod ends 14 and 16. Each rod end includes a bearing 14a and 16a, respectively, one of which is configured to connect to a flap and the other of which is configured to connect to an actuator. The bearings 14a and 16a are cartridge-type spherical plain bearings, each of which includes an outer ring 14b, 16b, within which a ball member 14c, 16c is disposed for sliding contact with the outer ring. The outer rings 14b, 16b are installed in mounting apertures formed in the rod ends. Each ball member 14c, 16c is respectively connected to a fastener, shaft, or other element on the flap and on the actuator. Operation of the actuator allows for changing the position of the flap via the strut 10 to direct the flow of exhaust from the nozzle, thereby providing for more or less thrust or otherwise accommodating a changing engine condition.

### SUMMARY OF THE INVENTION

The present invention resides in one aspect in a strut which includes a rod having a body member which has two opposite ends, with a first rod end at one end of the body member and a second rod end at the other end of the body member. The first rod end defines a first mounting aperture having a first interior surface, and there is a first ball member disposed in the first mounting aperture to form a first spherical plain bearing. The second rod end defines a second mounting aperture having a second interior surface, and there is a second ball member disposed in the mounting aperture to form a second spherical plain bearing. At least one of the first spherical bearing and the second spherical bearing does not include an outer ring.

The present invention resides in another aspect in a method of making a ball member. The method includes forming powdered chromium-cobalt alloy into an unfinished ball member having a rounded outer surface and an interior bore; machining the unfinished ball member using wire EDM to provide a machined ball member; and jig grinding a chamfer onto the machined ball member.

The present invention resides in another aspect in a method of making a strut. This method includes providing a rod which includes a body member having two opposite ends, a first rod end at one end of the body member and a second rod end at the other end of the body member, wherein the first rod end defines a first mounting aperture and the second rod end defines a second mounting aperture. The method further includes disposing a first ball member into the first mounting aperture without an outer ring to form a first spherical plain bearing; and disposing a second ball member in the second mounting aperture to form a second spherical plain bearing.

### BRIEF DESCRIPTION OF THE DRAWINGS

FIG. 1 is a schematic cross sectional view of a strut according to the prior art.

FIG. 2 is a schematic cross sectional view of a strut according to an exemplary embodiment of the invention.

FIG. 3 is a sectional view of one rod end of the strut of FIG. 2.

FIG. 4 is a side exploded view of the rod end of FIG. 3.

FIG. 5 is a sectional view of another rod end of the strut of FIG. 2.

FIG. 6 is a side exploded view of the rod end of FIG. 5.

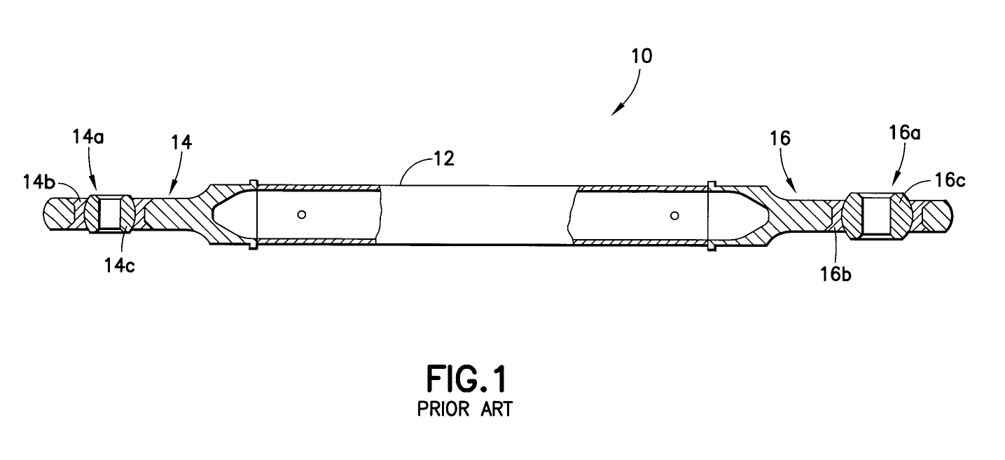

### DETAILED DESCRIPTION

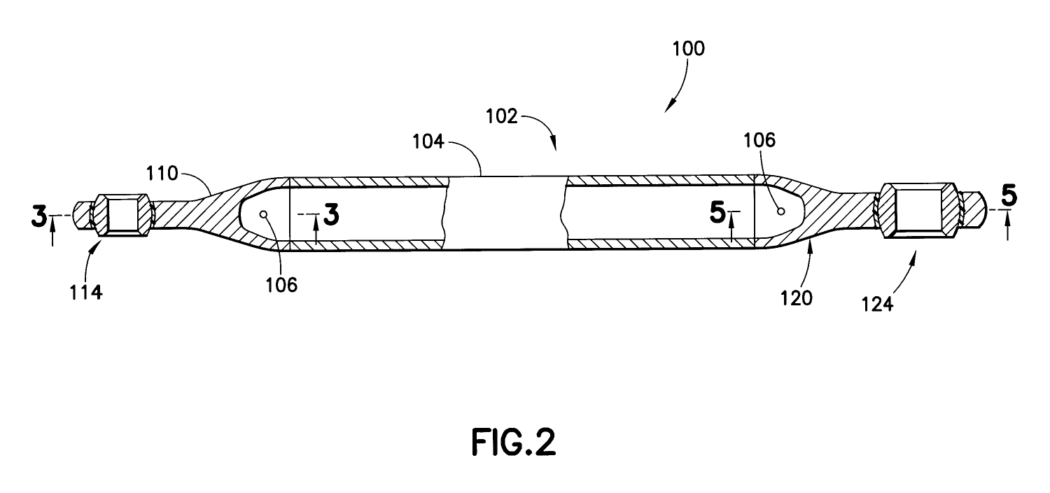

A strut shown generally at 100 in FIG. 2 includes a rod 102 comprised of a body member 104 having two opposite ends at which two rod ends 110 and 120 are respectively attached. As shown, the rod ends 110 and 120 are swaged to the body member 104. However, the invention is not limited in this regard, and in other embodiments, the rod ends 110 and 120 may be connected to the body mechanically (e.g., by screw thread engagement), or the rod ends may be welded onto the body or formed integrally with the body, or the rod ends may be attached by any other suitable means. In the illustrated embodiment, the body member 104 and adjoining portions of the rod ends 110 and 120 are hollow and include vent holes 106, but the invention is not limited in this regard, and in other embodiments, the body member 104 and/or the rod ends 110 and 120 may be solid or may have any other suitable configuration. The rod end 110 includes a spherical plain bearing 114, and the rod end 120 includes a spherical plain bearing 124.

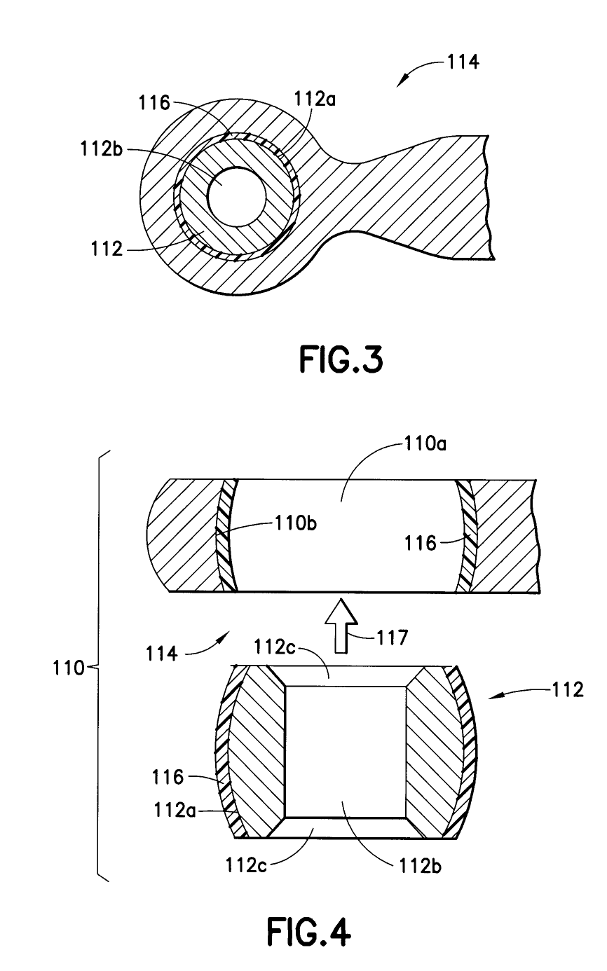

As is shown in FIG. 3, the spherical plain bearing 114 includes a ball member 112 mounted in the rod end 110 without an outer ring. In particular, a surface of the rod end 110 itself defines a mounting aperture within which the ball member 112 is situated. Referring to FIGS. 3 and 4, the mounting aperture (shown at 110a) has an interior surface 110b formed with a concave spherical configuration, and the ball member 112 has a ball surface 112a that has a convex spherical configuration so that upon insertion of the ball member into the mounting aperture 110a in the direction of an arrow 117 (for example, using a roll staking technique) the ball member forms the spherical plain bearing 114 in the rod end 110, without an outer ring mounted in the rod end. A dry lubricating film 116 may be disposed on one or both of the ball surface 112a and the receiving interior surface 110b. The ball member 112 has an interior ball aperture 112b to facilitate joining the rod end 110 to another structure. Chamfers 112c may be formed around the entrances to the interior ball aperture 112b.

As is shown in FIG. 5, the spherical plain bearing 124 is a low weight, high temperature bearing having a contoured geometry of suitable tolerance. This bearing is defined at least in part by a ball member 122 mounted in the rod end 120 without an outer ring. As with rod end 110, a surface of the rod end 120 defines a mounting aperture within which the ball member 122 is situated.

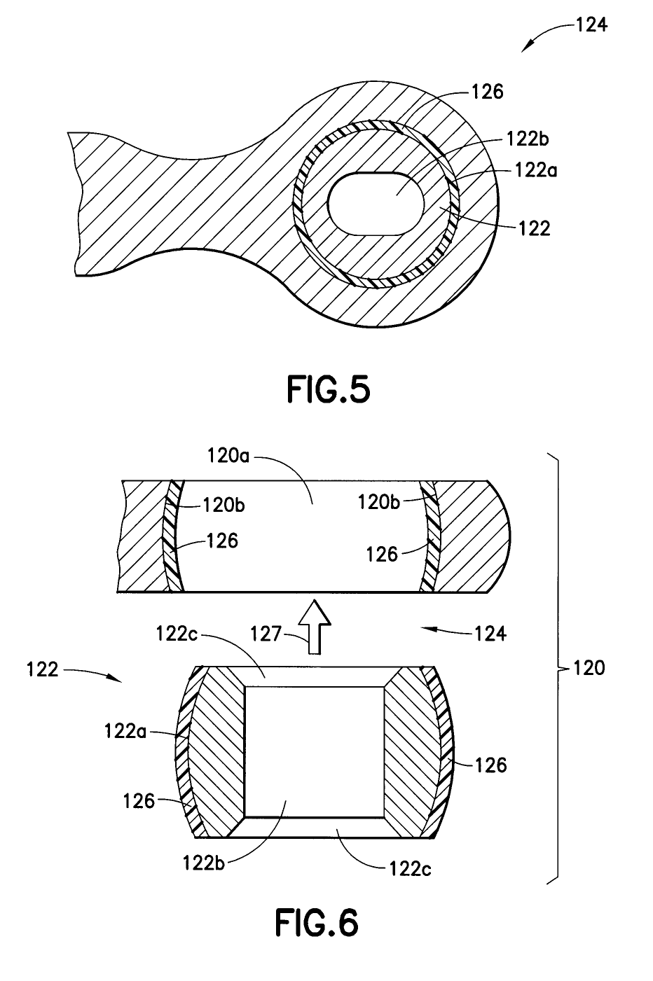

As is shown in FIGS. 5 and 6, the mounting aperture (shown at 120a) has an interior surface 120b formed with a concave spherical configuration. The ball member 122 has a ball surface 122a that has a convex spherical configuration. The ball member 122 forms a spherical plain bearing 124 with the rod end 120 when inserted into the mounting aperture 120a in the direction of an arrow 127 (for example, using a roll staking technique), without an outer ring member mounted in the rod end. The spherical plain bearing 124 is of a contoured geometry and is elliptical, elongated, oval or otherwise configured and machined to have a suitable tolerance between the ball surface 122a and the interior surface 120b. As with the rod end 110, a dry lubricating film 126 may be disposed on one or both of the ball surface 122a and the receiving interior surface 120b. The ball member 122 has an interior ball aperture 122b to facilitate joining the rod end 120 to another structure such as a shaft or for receiving a fastener. In one embodiment, chamfers 122c are formed around the entrances to the interior ball aperture 122b.

The dry lubricating films 116 and 126 may be the same as each other or different from each other, and may comprise any suitable dry lubricating material. For example, the dry lubricating films 116 and 126 may be polytetrafluoroethylene (PTFE) or a variation thereof, a molybdenum disulfide-type film, or a graphite-type film, or any other suitable dry lubricant, and may be adhered to a surface by means of a binder or by high intensity impingement on the surface. The present invention is not limited to the use of a dry lubricating film, however, as the interior surface and/or the ball surface may be defined by lubricious materials such as bronze, oil impregnated bronze, and the like.

In various embodiments, one or both of the rod ends 110 and 120 are formed from a high-temperature alloy, such as a nickel-chromium alloy. In one embodiment, the rod ends 110 and 120 are formed from an INCONEL® (a registered trademark of Huntington Alloys Corporation, a Delaware corporation with a place of business at 3200 Riverside Drive, Huntington, W.V.) alloy, e.g., INCONEL® 718.

In certain embodiments, one or both of the ball members 112, 122 are formed from a high-temperature alloy, such as a chromium-cobalt alloy. In one embodiment, one or both of the ball members 112, 122 are formed from a STELLITE® (a registered trademark of Deloro Stellite Holdings Corporation, a Delaware corporation with a place of business at 555 N. New Ballas, Ste. 305, St. Louis, Mo.) alloy, e.g., STELLITE® 3.

In a particular embodiment, the ball member 122 is formed from powdered metal which is molded and compacted using hot isostatic compaction, and the compacted powder is then sintered to form an unfinished ball member. The unfinished ball member is then machined to achieve the final dimensional features using a CNC (computer numerical control)-controlled wire EDM (Electrical Discharge Machining) process. In one embodiment, the chamfer 122b is machined using a jig grinder. However, the invention is not limited in this regard, and in other embodiments, the ball member 122 may be formed by other means. In various embodiments, the ball members 112 and 122 may be formed from the same material and using the same general process as each other, or from different materials and/or in by different processes from each other.

To assemble the strut 100, the ball members 112 and 122 are Roll staked into the respective mounting apertures 110a and 120a, for example, as shown in FIGS. 4 and 6.

The strut 100 is useful in a variety of applications, including in exhaust nozzles of gas turbines, for example, in the divergent exhaust nozzle on a jet aircraft.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced item.

Although the invention has been described with reference to particular embodiments thereof, it will be understood by one of ordinary skill in the art, upon a reading and understanding of the foregoing disclosure, that numerous variations and alterations to the disclosed embodiments will fall within the scope of this invention and of the appended claims.

What is claimed is:

1. A strut, comprising:
a rod comprised of a body member having two opposite ends, a first rod end at one end of the body member and a second rod end at the other end of the body member;
the first rod end defining a first mounting aperture having a first interior surface and having a first ball member disposed in the first mounting aperture to form a first spherical plain bearing;
the second rod end defining a second mounting aperture having a second interior surface and having a second ball member disposed in the mounting aperture to form a second spherical plain bearing; and
wherein one of the first spherical plain bearing and the second spherical plain bearing does not include an outer ring.

2. The strut of claim 1, including a dry lubricating film in the first spherical plain bearing, on at least one of the first ball member and a surface of the first rod end that receives the first ball member.

3. The strut of claim 1, wherein both the first spherical plain bearing and the second spherical plain bearing do not include an outer ring or race.

4. The strut of claim 1, wherein at least one of the first rod end and the second rod end is made from a nickel-chromium alloy.

5. The strut of claim 1, wherein at least one of the first ball member and the second ball member is made from a chromium-cobalt alloy.

6. The strut of claim 1, wherein at least one of the first ball member and the second ball member is made from a chromium-cobalt alloy and has an interior ball aperture having an elliptical configuration.

7. A method of making a ball member, comprising:
forming powdered chromium-cobalt alloy into an unfinished ball member having a spherical ball surface and an interior ball aperture;
wire machining the unfinished ball member using an electrical discharge machining process to provide a machined ball member; and
jig grinding chamfers around the entrances to the interior ball aperture.

8. The method of claim 7, wherein forming comprises molding, compacting, and sintering the powdered chromium-cobalt alloy.

9. A method of making a strut, comprising:
providing a rod comprised of a body member having two opposite ends, a first rod end at one end of the body member and a second rod end at the other end of the body member;
the first rod end defining a first mounting aperture having a first interior surface and the second rod end defining a second mounting aperture; and
roll staking a first ball member into the first mounting aperture without an outer ring, to form a first spherical plain bearing; and
disposing a second ball member in the second mounting aperture to form a second spherical plain bearing.

10. The method of claim 9, comprising swaging the second ball member into the second mounting aperture without an outer ring.
